(19) United States
(12) Patent Application Publication
(10) Pub. No.: US 2008/0041530 A1
(43) Pub. Date: Feb. 21, 2008

(54) Apparatus for Joining Veneers

(75) Inventor: Carsten Runge, Bad Essen (DE)

Correspondence Address: TIMOTHY F. BLISS, P.O. BOX 793968, DALLAS, TX, 75379, US

(73) Assignee: HEINRICH KUPER GMBH & CO., KG, RIETBERG GERMANY (DE)

(21) Appl. No.: 11/597,669

(22) PCT Filed: Apr. 18, 2005
(86) PCT No.: PCT/EP05/04114

§ 371 Date: Jul. 12, 2007

(30) Foreign Application Priority Data
May 24, 2004 (DE) 102004025431.1

(51) Int. Cl. B27D 1/10

(52) U.S. Cl. 156/546; 156/380.6

(57) ABSTRACT

The invention relates to a veneer joining apparatus having at least one slide bar along which the veneer pieces to be glued are guided, wherein a heating element is assigned to the slide bar. In order to enhance the known veneer joining apparatus, the invention provides that the heating element is integrated into the slide bar.

### CLAIM OF PRIORITY

This application claims priority from PCT Patent Application PCT/EP2005/004114, filed on Apr. 18, 2005, which claims priority from German Patent Application 102004025431.1, filed on May 24, 2004, both of which are incorporated herein by reference in their entirety.

### FIELD OF THE INVENTION

The invention relates to a veneer joining apparatus.

### BACKGROUND

Current veneer joining apparatuses have design characteristics that negatively impact their operation. Accordingly, what is needed is an improved veneer joining apparatus.

### SUMMARY

In one embodiment, a slide bar for use in a veneer joining apparatus comprises a cover, an insert, a heating element, and coupling means. The cover is formed at least partially of a thermal insulating material with a groove formed therein along a longitudinal axis of the cover. The insert is formed at least partially of a heat conducting material having a channel formed therein along the longitudinal axis, wherein the insert is retained within the groove. The heating element is formed at least partially of an electrically conductive material positioned within the channel and at least partially surrounded by the insert. The coupling means is for coupling the slide bar to the veneer joining apparatus.

In another embodiment, a veneer joining apparatus comprises first and second opposing slide bars, pressure applying means, and electrical means. The first and second opposing slide bars each have a thermally conductive insert with a channel formed therein along a longitudinal axis and an electrically conductive heating element positioned within the channel. The pressure applying means is for applying pressure to at least one of the first and second slide bars, and the electrical means is for supplying electricity to the heating elements of the first and second slide bars.

In yet another embodiment, a veneer joining apparatus has at least one slide bar along which veneer pieces to be glued are guided. The slide bar includes a groove extending along a longitudinal axis of the slide bar and an insert made of a flexible, heat conducting material positioned in the groove. The insert includes a reception groove for at least partially receiving a heating element therein.

### BRIEF DESCRIPTION OF THE DRAWINGS

FIG. 1 shows a schematic view of an inventive veneer joining apparatus,

FIG. 2 shows a schematic view of an inventive slide bar,

FIG. 3 shows the detail “A” of FIG. 2,

FIG. 4 shows the detail “B” of FIG. 2,

FIGS. 5a-5d show cross-sections of the inventive slide bar, illustrating the attachment of the slide bar in the cover, and

FIG. 6a-6d show cross-sections of the inventive slide bar, illustrating the attachment of the heating element in the slide bar.

In the illustration in the figures, only the components relevant for the invention are shown, all other constructive members have been omitted for a better clarity.

### WRITTEN DESCRIPTION

In veneer joining apparatuses, veneer pieces are glued to one another at their edgeways. The two veneer pieces to be glued are for this purpose cut into parallel strips. Subsequently, their edges are provided with glue and then they are glued together in the veneer joining apparatus. For this purpose, the veneer pieces are guided through a gluing zone by means of transport systems. In the gluing zone, a pressure is, on the one hand, applied to the seam formed between the veneer pieces to be glued and, on the other hand, the glue is hardened by heat treatment. The heat is usually generated by heating members in the form of electrical resistance wires which are arranged in heat conducting heaters such that they emit their heat to them. It has proven to be appropriate to arrange a plurality of heaters in series in order to emit the heat over a larger area to the slide bar. Thus, the slide bar extends across several heaters and therewith prevents that welts occur in the glued veneer. In order to prevent that the slide bar does not adhere to the glue in the seam, the slide bar is provided with an anti-stick coating. It is the object of the slide bar to transfer the heat into the glue and the adjacent seam area on the one hand and to keep the individual veneer pieces planar on the other hand.

Due to the fact that the resistance wires at first emit their heat to the heater and then to the slide bar, only an indirect heating of the slide bar is possible. Further, a complex construction results from the plurality of required heaters, which also prevents that the slide bar is sufficiently supported to apply the required pressure to the veneer pieces. In addition, the known heaters are relatively rigid bodies, which makes a flexible adjustment of the slide bar to veneers having a different thickness very difficult.

With the inventive embodiment, the heat is introduced directly into the slide bar, because the heating element is integrated into the slide bar. Therewith, a heat transfer can be omitted, such that a higher efficiency is guaranteed. Further, the heaters can be omitted completely, whereby the surfaces generating a heat loss are decreased. A further advantage lies in the fact that the slide bar can be supported at many points independent of the lengths of the heaters. The inventive embodiment also has the effect that the slide bar is flexible and therefore adjustable to the veneer, whereas the heaters used up to now formed rigid bodies and therefore could be adjusted only poorly to veneers having different thickness and to the leading and rear ends of the veneer pieces, which could lead to an offset of the seam.

Advantageous further developments result from the sub-claims.

According to a preferred embodiment, the heating element is formed as an elongated thin heating cartridge. Such heating cartridges are distributed e.g. by the company Hotset.

In order to secure a positionally correct arrangement of the heating element, the slide bar according to a preferred embodiment is provided with a groove extending in the longitudinal direction.

Preferably, an insert made of copper, bronze or an other flexible material having a good heat conductivity is disposed in the groove of the slide bar. This guarantees a good heat transfer from the heater element to the insert and from the insert to the veneer pieces.

According to a further preferred embodiment, a reception groove is formed in the insert for receiving the heating element at least partially.

In order to make sure that the heating element emits its heat output as lossless as possible to the slide bar, the heating element is preferably retained force-fit in the reception groove, in particular by means of a heat conducting glue.

According to a preferred embodiment, the slide bar is formed flexible in its longitudinal direction. Thus, a slide bar having an optimized cross-section and an optimum flexibility is obtained, the low section modulus of which enables a very good attachment to the veneer surface due to the plurality of force transmission points. Therewith, it is much easier to merge the edges of the veneer pieces to be glued in an exactly flush fitting manner.

According to a preferred embodiment, the slide bar has a thermally isolating cover which surrounds the insert at least at its longitudinal edges. This secures an only small heat loss to the environment as well as the adjacent transport members for the veneer pieces.

However, the cover may surround the slide bar also on three sides. This makes it possible to use heating temperatures of more than 200° C. without affecting the transport members made of plastics or similar sensitive materials, such as link chains made of plastics or tooth belts.

The connection between the slide bar and the cover can be obtained in two ways. According to one preferred embodiment, it is provided that the insert is connected to the cover through an interlocking connection, in particular a dovetail connection. This enables a simple attachment of the slide bar to the cover.

According to an alternative embodiment, the insert may also be connected to the cover by a force-fit connection, in particular be screwed or glued.

In order to guarantee a sufficient flexibility of the slide bar, the slide bar may preferably feature a flat cross-section.

For some applications, it may be advantageous if the insert is provided with a lug and the reception groove for the heating element is at least partially formed in the lug.

The heating element may be retained force-fit in the reception groove, in particular be glued. Alternatively, the heating element may also be retained in the groove in a flush fitting manner or through an additional holding member.

According to an alternative embodiment, the heating element may also be formed as a thin foil with conducting paths as a resistance heater instead of using a heating cartridge and may be attached directly on the slide bar.

Further features and advantages of the invention will be apparent from the following description of a preferred embodiment.

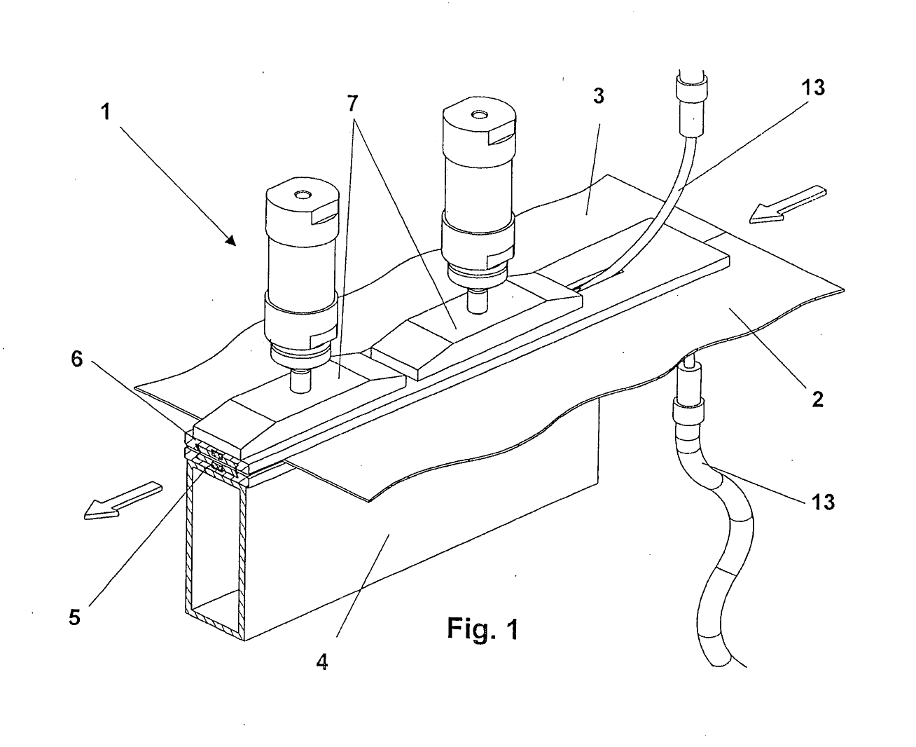

FIG. 1 shows schematically a structure of a veneer joining apparatus 1 in which individual veneer pieces 2, 3 are glued at their edges. The veneer joining apparatus 1 comprises a solid base 4, a lower slide bar 5, an upper slide bar 6 and pressure members 7. The veneer pieces 2, 3 are guided in direction of the arrow between the two slide bars 5, 6. The lower slide bar 5 is attached to the base 4, whereas the upper slide bar 6 is pressed against the lower slide bar 5 by means of the pressure members 7. The two slide bars 5, 6 can be heated such that the veneer pieces 2, 3 passed through between the slide bars 5, 6 are heated in the area of their seams. The upper slide bar 6 is flexible in itself, such that the pressure members 7 apply an optimum pressure to the veneer pieces 2, 3 in order to guide the edges to be glued of the veneer pieces 2, 3 in one plane.

In FIGS. 2 to 4, one of the two slide bars 5, 6 is shown in detail. Both slide bars 5, 6 are formed identically. They only differ in that the lower slide bar 5 is, due to its arrangement on the base 4, formed more rigidly, whereas the upper slide bar 6 is flexible in itself.

In FIG. 2, the upper slide bar 6 is shown. It comprises a cover 8 consisting of a thermally isolating plastics. Said cover 8 is provided with a groove 9. In this groove 9, an insert 10 is inserted such that the cover 8 surrounds the insert 10 on three sides. The insert 10 is made of a flexible material having a good heat conductivity, e.g. copper or bronze or the like. In the insert 10, a reception groove 11 extending in the longitudinal direction is provided, in which a heating element 12 is inserted. The heating element 12 is formed as an elongated thin heating cartridge, distributed e.g. by the company Hotset. The heating element 12 is provided with an energy supply 13 and is inserted into the slide bar 6 by means of a slit 14.

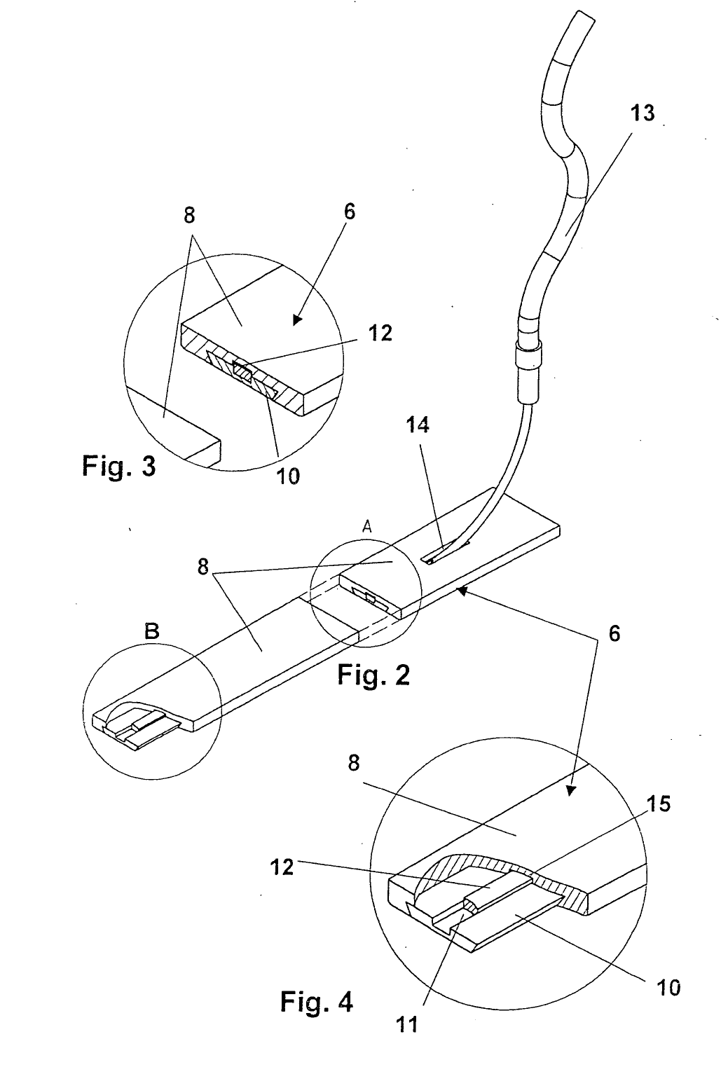

FIGS. 3 and 4 show the details “A” and “B” of the slide bar 6 shown in FIG. 2. It is apparent that the insert 10 is connected to the cover 8 in a flush fitting manner through a dovetail connection. Further, it is discernible that not only the insert 10 comprises a reception groove 11 for the heating element 12, but that also a reception groove 15 is present in the cover 8, such that the heating element 12 is placed partially in the insert 10 and partially in the cover 8.

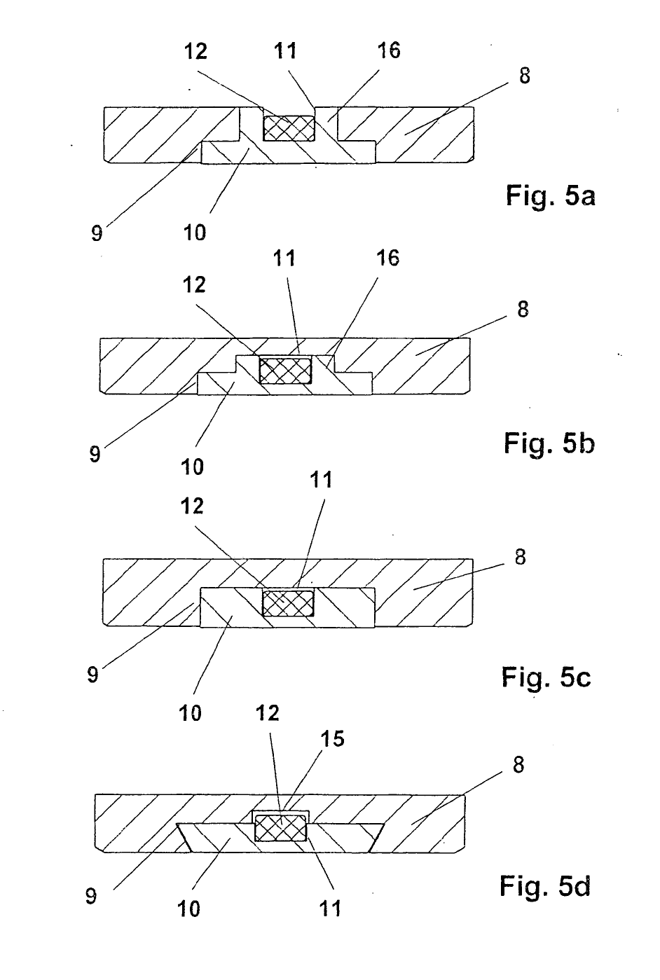

In FIGS. 5a to 5d, different cross-sections of the slide bar 6 are shown, from which it is apparent how the insert 10 and the cover 8 can be formed and connected to one another. In this context, it is important that the slide bar 6 is maintained as thin as possible, i.e. has a flat cross-section, in order to be flexibly adjustable to the veneer pieces 2, 3 in its longitudinal direction.

According to FIG. 5a, the cover 8 is only disposed on the two longitudinal sides of the insert 10. Herein, the insert has a substantially T-shaped cross-section and is provided with a lug 16 being open towards the top, extending to the top edge of the cover 8. In the lug 16, the reception groove 11 for the heating element 12 is disposed, said groove being open toward the top in this embodiment. The insert 10 may be glued to the cover 8, screwed or connected force-fit in an other manner thereto.

According to FIG. 5b, the cover 8 surrounds the insert 10 on three sides. Also in this case, the insert 10 is provided with a lug 16. Different from the depiction in FIG. 5a, in this case, the reception groove 11 for the heating element 12 is not exclusively disposed in the lug 16, but extends partially in the lug 16 and partially in the insert 10. Also in this embodiment, the insert 10 may be glued to the cover 8, screwed or connected force-fit in an other manner thereto.

According to FIG. 5c, the insert 10 has a square cross-section and comprises the reception groove 11 for the heating element 12, said groove extending in the longitudinal direction. The cover 8 surrounds the insert 10 on three sides, as in FIG. 5b. The connection between the insert 10 and the cover 8 is also in this case effected force-fit.

According to FIG. 5d, a flush fitting connection between the insert 10 and the cover 8 is discernible. The flush fitting connection is preferably effected in the form of a dovetail connection. As already explained in connection with FIGS. 2 to 4, the embodiment shown here provides a reception groove 11, 15 respectively in the insert 10 as well as in the cover 8, such that the heating element 12 is partially received in the insert 10 and partially received in the cover 8.

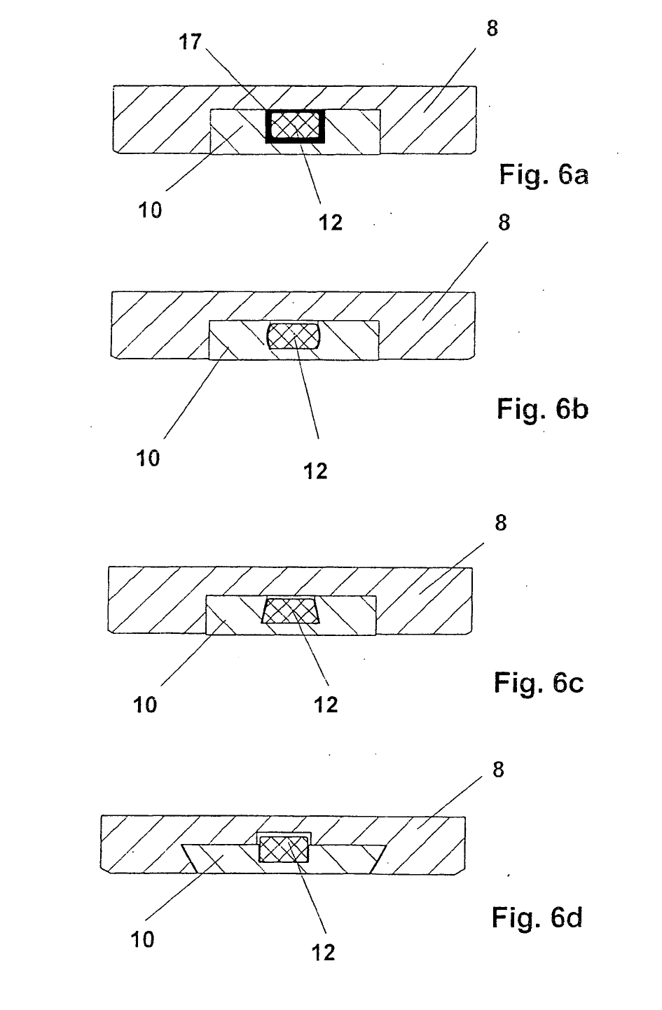

In FIGS. 6a to 6d, different cross-sections of the slide bar 6 are shown, from which it can be seen how the heating element 12 is fixed in the insert 10.

According to FIG. 6a, the heating element 12 is connected to the insert 10 by means of a heat conducting glue 17.

According to FIG. 6b, a connection is shown in which the reception groove 11 in the insert 10 has a barrel-shaped cross-section. The heating element 12 is press-fitted into said barrel-shaped reception groove 11.

According to FIG. 6c, the cross-section of the reception groove 11 is trapezoid such that a flush fitting connection between the heating element 12 and the insert 10 is obtained.

According to FIG. 6d, the heating element 12 is placed loosely into the reception groove 11. The heating element is retained in the reception groove 11 by a plastics cover which is fixed flush-fittingly to the insert 10.

In all embodiments, the insert 10 slightly protrudes beyond the lower edge of the cover 8 to guarantee a direct heat transfer between the heating element 12 and the veneer pieces 2, 3. In addition, it is discernible that the heating element 12 features a certain tolerance towards the top in order to enable a heat expansion.

In the foregoing, different embodiments were described in connection with the upper slide bar 6, however, the same embodiments also apply for the lower slide bar 5.

According to a not-shown embodiment, the heating element 12 may also be directly attached to the slide bars 5, 6 or the insert 10, respectively, as a thin foil with conducting paths as resistance heaters.

The above description of the embodiments according to the present invention is only given for illustrative purposes and not for limiting the invention. Within the scope of the invention, different alterations and modifications may be made without deserting the scope of the invention and its equivalents.

### LIST OF REFERENCE NUMERALS

1 veneer joining apparatus
2 veneer piece
3 veneer piece
4 base
5 lower slide bar
6 upper slide bar
7 pressure member
8 cover
9 groove
10 insert
11 reception groove
12 heating element
13 energy supply
14 slit
15 reception groove
16 lug
17 glue

What is claimed is:

1. A slide bar for use in a veneer joining apparatus comprising:
a cover formed at least partially of a thermal insulating material with a groove formed therein along a longitudinal axis of the cover;
an insert formed at least partially of a heat conducting material having a channel formed therein along the longitudinal axis, wherein the insert is retained within the groove;
a heating element formed at least partially of an electrically conductive material positioned within the channel and at least partially surrounded by the insert; and
coupling means for coupling the slide bar to the veneer joining apparatus.

2. The slide bar of claim 1 wherein a first portion of the channel is formed by a reception groove in the insert along the longitudinal axis and a second portion of the channel is formed by a surface of the groove in the cover.

3. The slide bar of claim 1 wherein the channel is enclosed and the insert completely surrounds the heating element along the longitudinal axis.

3. The slide bar of claim 1 wherein the cover, insert, and heating element are flexible.

4. The slide bar of claim 3 wherein the heating element is a flat elongated strip of the electrically conductive material.

5. The slide bar of claim 1 further comprising a removable electrical connection means for providing electrical current to the heating element.

6. The slide bar of claim 1 wherein the cover includes a slit for passage of an electrical connector through the cover to the heating element.

7. A veneer joining apparatus comprising:
first and second opposing slide bars, each slide bar having a thermally conductive insert with a channel formed therein along a longitudinal axis and an electrically conductive heating element positioned within the channel;
pressure applying means for applying pressure to at least one of the first and second slide bars; and
electrical means for supplying electricity to the heating elements of the first and second slide bars.

8. The veneer joining apparatus of claim 7 wherein the first slide bar is flexible.

9. The veneer joining apparatus of claim 8 wherein the second slide bar is rigid.

10. The veneer joining apparatus of claim 7 further comprising movement means for moving the slide bars relative to veneers being joined.

11. A veneer joining apparatus having at least one slide bar along which veneer pieces to be glued are guided, wherein the slide bar includes a groove extending along a longitudinal axis of the slide bar and an insert made of a flexible, heat conducting material positioned in the groove, and wherein the insert includes a reception groove for at least partially receiving a heating element therein.

12. The veneer joining apparatus of claim 11, wherein the heating element is formed as an elongated thin heating cartridge.

13. The veneer joining apparatus of claim 11 wherein the heating element is retained in the reception groove by means of a heat conducting glue.

14. The veneer joining apparatus of claim 11 wherein the heating element is retained in the reception groove so that an exposed surface of the heating element is flush with a top of the reception groove.

15. The veneer joining apparatus of claim 11 wherein the slide bar is flexible along its longitudinal axis.

16. The veneer joining apparatus of claim 11 wherein the slide bar includes a thermally isolating cover surrounding the insert at least along longitudinal edges of the insert that run parallel to the longitudinal axis.

17. The veneer joining apparatus of claim 16 wherein the cover surrounds the insert on three sides.

18. The veneer joining apparatus of claim 16 wherein the insert is coupled to the cover using a dovetail connection.

19. The veneer joining apparatus of claim 16 wherein the insert is coupled to the cover using at least one of a screw means or a glue means.

20. The veneer joining apparatus of claim 11 wherein the slide bar has a flat cross-section.

21. The veneer joining apparatus of claim 11 wherein the insert includes a lug and the reception groove is formed at least partially in the lug.

22. The veneer joining apparatus of claim 11 wherein the heating element is retained in the reception groove by a holding member.

23. The veneer joining apparatus of claim 11 wherein the heating element is formed as a thin foil having conductive paths thereon and attached directly to at least one of the slide bar and the insert.
